(19) United States
(12) Patent Application Publication
(10) Pub. No.: US 2002/0179707 A1
(43) Pub. Date: Dec. 5, 2002

(54) Smart card reader circuit and insertion detection method

(75) Inventor: Dominique Omet, (US)

Correspondence Address: ON Semiconductor, Patent Administration Dept -MD A230, P.O. Box 62890, Phoenix, AZ, 85082, US

(73) Assignee: Semiconductor Components Industries, LLC.

(21) Appl. No.: 09/872,806

(22) Filed: Jun. 4, 2001

(51) Int. Cl. G06K 7/08

(52) U.S. Cl. 235/451

(57) ABSTRACT

An integrated smart card reader circuit (10) includes a first signal path (64, 65) that is enabled by a first value of programming data (POL) for routing a card insertion signal (CRDDET) from a first lead (42) to a second lead (32) of the card reader circuit as a detection signal (INT). A second signal path (66, 67) operates in response to a second value of the programming data, and is coupled to the first lead for inverting the card insertion signal to produce the detection signal at the second lead. The programming data is indicative of the polarity of the card insertion signal, which depends on the type of detection switch (17) used to determine when a smart card (15) is inserted in a card reader (8).

### BACKGROUND OF THE INVENTION

The present invention relates in general to semiconductor devices and, more particularly, to integrated interface circuits used in smart card readers to detect when a smart card is present.

Smart cards are small plastic devices which contain one or more embedded integrated circuits that store a user's personal data as well as software programs for running smart card applications. The personal data is accessed, and the smart card is programmed, with a smart card reader that has an aperture or slot for inserting the smart card. Terminals are formed within the aperture to provide power and data transfer connections between terminals of the smart card and leads of an integrated interface circuit within the smart card reader.

The aperture typically includes a mechanical switch that is activated when a smart card is inserted to provide a card insertion signal that is detected by the interface circuit. Some card readers use normally open switches that close when a card is inserted while other card readers use a normally closed switch that opens when a card is inserted. The normally open switches produce a card insertion signal whose value is logic low when a card is inserted while normally closed switches produce a logic high card insertion signal when a card is inserted.

In order to accommodate the different polarities of the card insertion signal, existing interface circuits have an extra lead which is hard wired during fabrication to a node whose logic value indicates the type of switch being used in the card reader. For example, a card reader using a normally open switch may connect the extra lead to a power supply terminal to provide a logic high state, while a card reader using a normally closed switch may connect the extra lead to ground potential to provide a logic low state. However, the extra lead has a disadvantage of increasing the lead count of the interface circuit package, which increases the size and manufacturing cost of the interface circuit and card reader.

Hence, there is a need for an integrated interface circuit for a smart card reader that detects when a smart card is inserted but does not need an extra lead to distinguish between different insertion signal values in order to maintain a small size and low fabrication cost of the interface circuit and card reader.

### BRIEF DESCRIPTION OF THE DRAWINGS

FIG. 1 shows a schematic diagram of a smart card and a card reader; and

FIG. 2 shows a schematic diagram of an interface circuit of the smart card reader.

### DETAILED DESCRIPTION OF THE DRAWINGS

In the figures, elements having the same reference numbers have similar functionality.

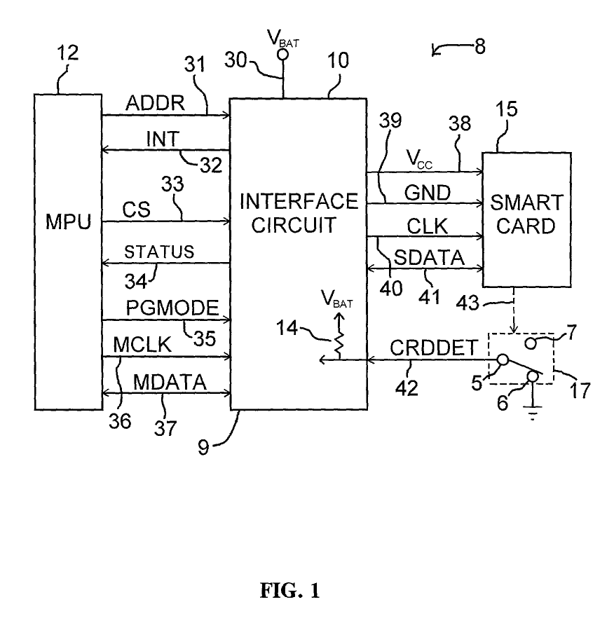

FIG. 1 is a schematic diagram of a smart card reader 8 for reading from and writing to a smart card 15. Card reader 8 includes a microprocessor (MPU) 12, a detection switch 17 and an interface circuit 10. Card reader 8 operates from a battery supply voltage V_{BAT} whose value ranges from about 2.7 to about 6.0 volts. Card reader 8 typically includes an aperture or slot (not shown) into which smart card 15 is inserted in order to commence communication. Terminals 38-43 are formed within the aperture for connecting card reader 8 to smart card 15.

Smart card 15 includes one or more embedded integrated circuits that store and transfer information through interface circuit 10 to MPU 12. Smart card 15 may be either a three volt smart card specified to operate from V_{CC}=3.0 volts or a five volt smart card operating from V_{CC}=5.0 volts, in accordance with current global standards.

MPU 12 is configured as an eight bit microcontroller that is programmed to execute software applications to control, process and update information stored on smart card 15. MPU 12 has a plurality of leads coupled to leads 31-37 of interface circuit 10 for processing and transferring information to smart card 15 through interface circuit 10. MPU 12 and card reader 8 are configured to function in either of two modes: an operating mode and a programming mode. In the operating mode, MPU 12 performs operations such as transferring SDATA from smart card 15 to MPU 12 as MDATA for reading smart card 15, or transferring MDATA to smart card 15 as SDATA to access and/or modify information stored on smart card 15. In the programming mode, MPU 12 programs the functionality of interface circuit 10. For example, MPU 12 may program interface circuit 10 to provide the correct value for supply voltage V_{CC} across terminals 38-39.

MPU 12 receives a detection signal INT generated by interface circuit 10 on lead 32 to request the attention of MPU 12. In one embodiment, interface circuit 10 generates INT with a logic high to logic low transition to indicate that smart card 15 has been inserted. MPU 12 then initiates a handshaking routine that detects the smart card type and initiates the programming mode to program the functionality of interface circuit 10.

An edge sensitive enabling signal CS is provided on lead 33 to activate interface circuit 10, and a mode control signal PGMODE is produced on lead 35 to control whether card reader 8 is functioning in the operating or programming mode. When PGMODE is logic high and CS makes a logic high to logic low transition, card reader 8 is in the operating mode. When CS makes a logic high to logic low transition and PGMODE is low, card reader 8 is in the programming mode. When CS makes a logic low to logic high transition, the programming mode terminates and the programmed state is retained in interface circuit 10. A clock signal MCLK is provided on lead 36 for synchronizing data transfers and other functions.

A selection signal ADDR is provided on lead 31 for polling a monitor circuit within interface circuit 10 that monitors various operating conditions of card reader 8 in order to avoid damage or corrupted data. For example, one value of ADDR selects a V_{CC} monitor that samples the value of V_{CC} to ensure that smart card 15 has a supply voltage adequate to function correctly. In one embodiment, lead 31 functions as a bus that provides two bits of parallel binary ADDR data for polling the status of four operating conditions of card reader 8. Interface circuit 10 responds to the ADDR data by producing a status signal STATUS on lead 34 to indicate whether the corresponding operating condition has become a fault condition so MPU 12 can take an appropriate corrective action.

Detection switch 17 is disposed in the aperture of card reader 8 and activated when smart card 15 is inserted to provide a card insertion signal CRDDET on terminal 42. The mechanical control of switch 17 is represented by a control line 43. In one embodiment, switch 17 is normally open and closes when smart card 15 is inserted. A pull-up resistor 14 internal to interface circuit 10 is coupled to V_{BAT} to set the value of insertion signal CRDDET to be logic high when no smart card is present. When smart card 15 is inserted, switch 17 closes as shown to ground terminal 42 and set CRDDET to a low logic level. A low logic value of CRDDET is processed in interface circuit 10 to initiate a logic high to logic low transition of detection signal INT. In an alternative embodiment, switch 17 is normally closed, so that inserting smart card 15 results in generating a logic high value of CRDDET, while interface circuit 10 is programmed to provide a logic high to logic low transition of INT. Hence, depending on the application, CRDDET can have either a logic high or a logic low value to indicate that a smart card has been inserted. Interface circuit 10 is programmed as described below to respond to the appropriate polarity or value of CRDDET to ensure that detection signal INT is generated with a logic high to logic low transition.

Interface circuit 10 includes analog and digital circuitry for performing specified interface functions between MPU 12 and smart card 15. For example, interface circuit 10 provides level shifting and synchronization of microprocessor data MDATA transferred through lead 37 to produce smart card data SDATA which is transferred through terminal 41 to smart card 15. Synchronization is provided by a clock signal CLK on terminal 40 for operating smart card 15. In some applications, CLK operates at a lower clock frequency than CLOCK, so interface circuit 10 includes a clock divider that reduces the frequency of CLOCK to produce CLK. Interface circuit 10 includes a direct current to direct current (DC-DC) converter that generates the smart card power supply across leads coupled to terminals 38-39 as supply voltage V_{CC} and ground potential GND, respectively. Interface circuit 10 is formed as a semiconductor die and housed in a semiconductor package 9 that includes at least leads 31-37 and leads coupled to terminals 38-42. Alternatively, interface circuit 10 and MPU 12 may be formed on the same semiconductor die and provided in a single package.

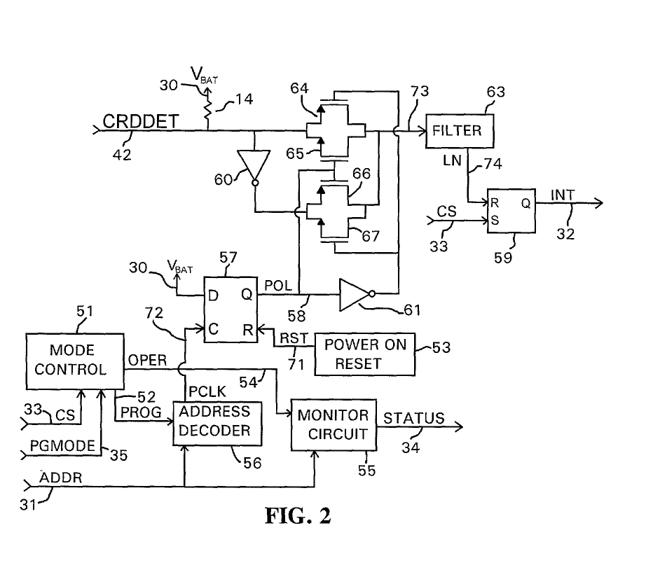

FIG. 2 is a schematic diagram of interface circuit 10 shown in further detail, including a mode control circuit 51, a power on reset circuit 53, a monitor circuit 55, an address decoder 56, a data flip-flop 57, a latch 59, inverters 60-61, a filter 63 and transistors 64-67. Interface circuit 10 produces detection signal INT on lead 32 with a logic low value to indicate that smart card 15 has been inserted, regardless of whether switch 17 is a normally open or normally closed type. That is, INT is generated with a logic low value regardless of the polarity of card insertion signal CRDDET.

Mode control circuit 51 is activated when enabling signal CS makes a logic high to logic low transition. An input coupled to lead 35 receives control signal PGMODE to control whether interface circuit 10 functions in the operating mode or the programming mode. To select the programming mode to allow MPU 12 to program the functionality of interface circuit 10, PGMODE is set to logic low while CS makes a logic high to low transition that produces a programming signal PROG at an output coupled to a node 52. To select the operating mode, PGMODE is logic high while CS makes a logic high to low transition that produces an operating signal OPER at an output at a node 54.

Monitor circuit 55 is activated during the operating mode by operating signal OPER to monitor various operating conditions of card reader 8 in order to detect conditions that could result in component damage and/or data corruption. A sequence of ADDR values are generated at lead 31 to sequentially activate sense circuits within monitor circuit 55, and a corresponding series of status values are provided on lead 34 as status signal STATUS.

Address decoder 56 is active during the programming mode to generate a clocking signal PCLK at an output 72 that stores programming data in data flip-flop 57. A first input is coupled to node 52 to receive programming signal PROG. A second input is coupled to lead 31 to receive selection signal ADDR that is decoded to produce a high to low logic transition of clocking signal PCLK on output 72.

Power on reset circuit 53 includes timing circuitry to produce a default signal RST on a node 71 to establish a default value of programming data for storing in flip-flop 57. The default value represents the type of detection switch 17 used in card reader 8. For example, in one embodiment where switch 17 comprises a normally open switch, RST resets flip-flop 57 to indicate that CRDDET has a logic low value when smart card 15 is inserted.

Data flip-flop 57 is a standard logic flip-flop that functions as a storage device or element. A data input is coupled to a node 30 to receive supply voltage V_{BAT} as a logic high value which represents a value of programming data indicative of a normally closed switch type. An output is coupled to a node 58 for storing the programming data as a polarity signal POL. In one embodiment, polarity signal POL is set to a default low value by power on reset circuit 53 when power is applied to represent a normally open switch type and a logic low CRDDET polarity.

Programming data is stored in flip-flop 57 as follows. If switch 17 is normally open, the default value of POL is not altered when smart card 15 is inserted. However, if card reader 8 is configured with a normally closed switch in which CRDDET is logic high when smart card 15 is inserted, MPU 12 sets PGMODE low and generates a high to low transition of CS to produce a high to low transition of PROG on node 52. A predefined value of ADDR is provided on lead 31 and decoded by address decoder 56 to produce a high to low transition of clocking signal PCLK that the logic high value at the data input to store a logic high POL value in flip-flop 57. In effect, both the logic high value of the data input of flip-flop 57 and default signal RST represent values of programming data that indicate the appropriate polarity of CRDDET. Hence, a logic low value of POL is stored if switch 17 is a normally open type and logic high POL value is stored if switch 17 is a normally closed type.

Filter 63 is a low pass filter used to reduce switching noise when smart card 15 is inserted. In one embodiment, filter 63 is set to suppress noise pulses produced by mechanical bounce of switch 17 that is shorter than fifty microseconds when smart card 15 is inserted. Further debouncing with a longer time constant is provided by a routine executed by MPU 12. A reduced noise signal LN is provided on an output coupled to a node 74.

Latch 59 functions as a set-reset flip-flop that is reset by reduced noise signal LN and set by control signal CS as shown. An output is coupled to lead 32 to produce detection signal INT. Note that INT is set by the leading edge of CRDDET, regardless of its polarity, and reset or updated by CS.

Transistor 64 comprises a p-channel metal-oxide-semiconductor field effect transistor (MOSFET) and transistor 65 comprises an n-channel MOSFET. Transistors 64 and 65 function as a transmission gate or switch that provides a first signal path for routing insertion signal CRDDET from terminal 42 to node 73. Transistors 64 and 65 are enabled when polarity signal POL is logic high and disabled when POL is logic low.

Transistors 66 and 67 are p-channel and n-channel MOSFETs, respectively, that function as a transmission gate or switch that provides a second signal path for inverting CRDDET with inverter 60 and routing CRDDET from terminal 42 to node 73. Transistors 66 and 67 are enabled when polarity signal POL is logic low and disabled when POL is logic high.

Interface circuit 10 detects the insertion of smart card 15 as follows. First, assume that switch 17 is a normally open type so that CRDDET has a logic low value to indicate when smart card 15 is present. Since the default value of CRDDET is logic low, the value of polarity signal POL is set by default signal RST and stored in flip-flop 57. MPU 12 does not initiate the programming mode to alter the value of POL. Hence, transistors 66 and 67 are turned on to route CRDDET from terminal 42 through inverter 60, transistors 66-67, filter 63 and latch 59 to lead 32 as detection signal INT. INT is generated with a logic high to logic low transition when smart card 15 is inserted.

If switch 17 is a normally closed type, CRDDET has a logic high value when smart card 15 is present. MPU 12 initiates the programming mode by setting PGMODE low and providing a high to low transition of CS to activate PROG. A predefined value of ADDR is provided to address decoder 56 to produce a low to high transition of clocking signal PCLK that stores a logic high value of POL. Transistors 64 and 65 are turned on and CRDDET is routed from terminal 42 through transistors 64-65, filter 63 and latch 59 to lead 32 as detection signal INT. INT thereby makes a logic high to logic low transition when smart card 15 is inserted.

Note that detection signal INT makes a transition from logic high to logic low to indicate to MPU 12 that smart card 15 has been inserted regardless of the polarity of CRDDET or the type of switch 17 being used. Polarity signal POL functions as programming data whose default value is established during startup and stored in flip-flop 57. The default value is modified in the programming mode by providing a predefined value of ADDR on lead 31 to activate clocking signal PCLK. The need for additional package leads is avoided because lead 31 is already used to provide a sequence of ADDR values to monitor circuit 55 for monitoring a series of operating conditions of interface circuit 10. By using lead 31 for different functions in the operating and programming modes, a low lead count of interface circuit 10 is achieved so a smaller package can be utilized to reduce the size and manufacturing cost of card reader 8.

In summary, the present invention provides a card reader circuit and method of card insertion detection. A first signal path operates in response to a first value of programming data for routing a card insertion signal from a first lead to a second lead of the card reader circuit as a detection signal. A second signal path operates in response to a second value of the programming data for inverting the card insertion signal at the first lead to produce the detection signal at the second lead. The programming data is indicative of the value of the card insertion signal and/or the type of detection switch used in the card reader. The card reader has a programming mode in which a storage clock signal is activated by a predefined value of a selection signal, and an operating mode in which the selection signal is used for monitoring operating conditions. Hence, the card reader circuit selects the storage clock signal on a lead that is already being used for another function, thereby avoiding the need for an extra lead so the card reader circuit can be housed in a low lead count package. As a result, the card reader circuit is fabricated with a smaller size and lower cost than other card readers.

What is claimed is:

1. A card reader circuit, comprising:
a first signal path operating in response to a first value of programming data for routing a card insertion signal from a first lead of the card reader circuit to a second lead of the card reader circuit as a detection signal; and
a second signal path operating in response to a second value of the programming data and coupled to the first lead for inverting the card insertion signal to produce the detection signal at the second lead.

2. The card reader circuit of claim 1, further comprising a storage element having an input coupled to a node for storing the programming data and an output coupled for enabling the first and second signal paths.

3. The card reader circuit of claim 2, further comprising a monitor circuit having an input coupled to the node for enabling the monitor circuit to sense an operating condition of the card reader circuit.

4. The card reader circuit of claim 2, wherein the first signal path includes:
a first transistor having a first conduction electrode coupled to the first lead, a second conduction electrode coupled to the second lead, and a control electrode coupled to the output of the storage element;
a first inverter having an input coupled to the output of the storage element; and
a second transistor having a first conduction electrode coupled to the first lead, a second conduction electrode coupled to the second lead, and a control electrode coupled to an output of the first inverter.

5. The card reader circuit of claim 4, wherein the second signal path includes a second inverter having an input coupled to the first lead for inverting the card insertion signal.

6. The card reader circuit of claim 5, wherein the second signal path further includes:
a third transistor having a first conduction electrode coupled to an output of the second inverter, a second conduction electrode coupled to the second lead, and a control electrode coupled to the input of the first inverter; and
a fourth transistor having a first conduction electrode coupled to the output of the second inverter, a second conduction electrode coupled to the second lead, and a control electrode coupled to the output of the first inverter.

7. The card reader circuit of claim 1, further comprising a latch having a first input coupled to outputs of the first and second signal paths, and an output coupled to the second lead for providing the detection signal.

8. The card reader circuit of claim 1, further comprising a semiconductor package for housing the first and second signal paths.

9. A method of detecting a smart card, comprising the steps of:
routing a card insertion signal through a first signal path to a first package lead to produce a detection signal when programming data has a first value; and
inverting the card insertion signal through a second signal path to produce the detection signal when the programming data has a second value.

10. The method of claim 9, further comprising the step of storing the programming data in a storage element.

11. The method of claim 10, wherein the step of storing includes the step of clocking the storage element with a programming signal to store the programming data.

12. The method of claim 9, wherein the step of routing includes the steps of:
enabling a first transistor with the first value of the programming data to couple a first transition of the card insertion signal to the first package lead as a first transition of the detection signal; and
enabling a second transistor with the first value of the programming data to couple a second transition of the card insertion signal to the first package lead as a second transition of the detection signal.

13. The method of claim 12, wherein the step of enabling a first transistor includes the step of inverting the first value of the programming data.

14. The method of claim 9, wherein the step of inverting includes the steps of:
enabling a third transistor with the second value of the programming data to couple the second transition of the card insertion signal to the first package lead as the first transition of the detection signal; and
enabling a fourth transistor with the second value of the programming data to couple the first transition of the card insertion signal to the node as the second transition of the detection signal.

15. The method of claim 9, further comprising the step of filtering the card detection signal to reduce a noise component of the detection signal.

16. The method of claim 15, wherein the step of filtering includes the steps of:
latching the card insertion signal for a time period; and
resetting the card insertion signal after the time period.

17. An interface circuit for a card reader, comprising:
a first switch having a control electrode responsive to a first value of programming data for coupling an insertion signal from a first lead to a second lead of the interface circuit as a detection signal; and
a second switch having a control electrode responsive to a second value of the programming data for inverting the insertion signal to produce the detection signal at the second lead.

18. The card reader circuit of claim 17, further comprising a memory device having an output for storing the programming data.

19. The card reader circuit of claim 17, wherein the first switch comprises a first transmission gate that forms a conduction path between the first and second leads with the first value of the programming signal.

20. The card reader circuit of claim 19, wherein the second switch includes:
an inverter having an input coupled for receiving the insertion signal; and
a second transmission gate that operates in response to the second value of the programming signal for providing a conduction path between the second lead and an output of the inverter.
